(19) United States
(12) Patent Application Publication
(10) Pub. No.: US 2005/0088496 A1
(43) Pub. Date: Apr. 28, 2005

(54) Ink refilling cap

(76) Inventors: Pui Kuong Lui, Kowloon (HK); Yiu Cheong Law, Kowloon (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/689,694

(22) Filed: Oct. 22, 2003

(51) Int. Cl. B41J 2/175

(52) U.S. Cl. 347/86

(57) ABSTRACT

An ink refilling cap is adapted to an ink cartridge. The ink refilling cap includes at least three casings and a base seat on which the casings are mounted. The casings each include a top wall having an air vent and a circuitous channel formed on a surface thereof and in communication with the air vent. Each of the casings has an accommodating space for filled with different colors of liquid ink. Each of the casings has a drain conduit extending downwardly from a bottom thereof. Furthermore, the ink refilling cap is assembled on an ink container of the ink cartridge for refilling ink therefrom when the ink in the container is depleted.

### BACKGROUND OF THE INVENTION

1. Field of the Invention

The present invention relates to an ink cartridge and, more particularly to an ink refilling cap assembled on an ink container of the ink cartridge for refilling ink therefrom.

2. Description of the Related Art

In general, ink jet printers are a popular form of printer used with computers and similar applications involving document printing or graphics preparation. Typical ink jet printers have replaceable ink jet cartridges, hence the cartridges provided by printer manufactures are typically not designed to be refilled when the ink supply runs out. However, the need to provide ink refilling is especially acute in the case of color ink cartridges, because typically one color will run out of ink before the other colors are depleted. It is well known, that refilling ink cartridges with ink is not an easy task. First, some means must be provided to break open the cartridges. Then, the ink reservoirs are typically filled with foam, and the ink refilling process is slow due to slow absorption of ink by the foam. Referring to FIG. 1, a prior art ink cartridge 1a has an ink container 10a and an ink cap 11a assembled on the ink container 10a. The ink container 10a has a plurality of internal ink reservoirs 12a, 13a, 14a typically filled with different colors of liquid ink 15a. The ink cartridge 1a can be broken open by separating the ink container 10a and the ink cap 11a. One convenient way to do so is by using the ink cartridge opener.

Thus, there presently exists a need for simple and inexpensive design to refill the ink into the ink cartridge without opening the ink cap, such that internal ink reservoirs can be replenished for renewed use.

### SUMMARY OF THE INVENTION

It is therefore a principal object of the invention to provide an ink refilling cap assembled on an ink container of an ink cartridge for refilling ink therefrom when the ink in the container is depleted. Furthermore, the present invention has been accomplished to eliminate the aforesaid problem.

To achieve the above object, the present invention provides an ink refilling cap adapted to an ink cartridge. The ink refilling cap includes at least three casings and a base seat on which the casings are mounted. The casings each include a top wall having an air vent and a circuitous channel formed on a surface thereof and in communication with the air vent. Each of the casings has an accommodating space for filled with different colors of liquid ink. Each of the casings has a drain conduit extending downwardly from a bottom thereof. The base seat has at least three holes for providing the drain conduits of the casings to pass through, correspondingly.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of an ink cartridge of a prior art;

FIG. 2 is a perspective view of an ink refilling cap of the present invention;

FIG. 3 is a side view of the ink refilling cap of the present invention;

FIG. 4 is an exploded perspective view of an ink cartridge of the present invention;

FIG. 5 is a perspective view of the ink cartridge of the present invention; and

FIG. 6 is a schematic view of the ink refilling cap in operation.

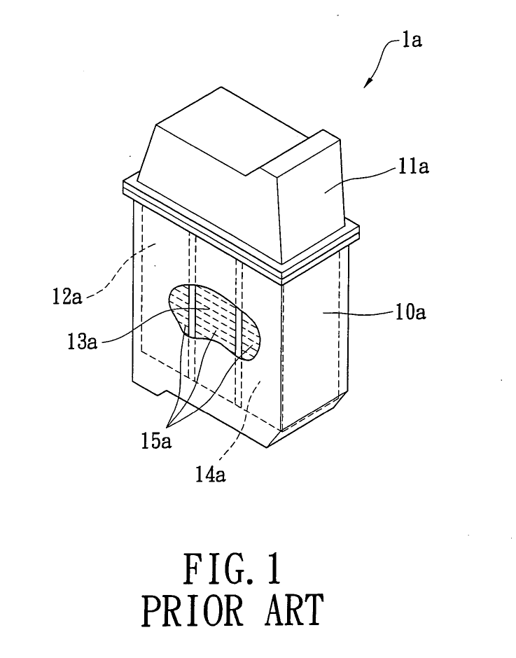

### DETAILED DESCRIPTION OF THE EMBODIMENTS

Wherever possible in the following description, like reference numerals will refer to like elements and parts unless otherwise illustrated.

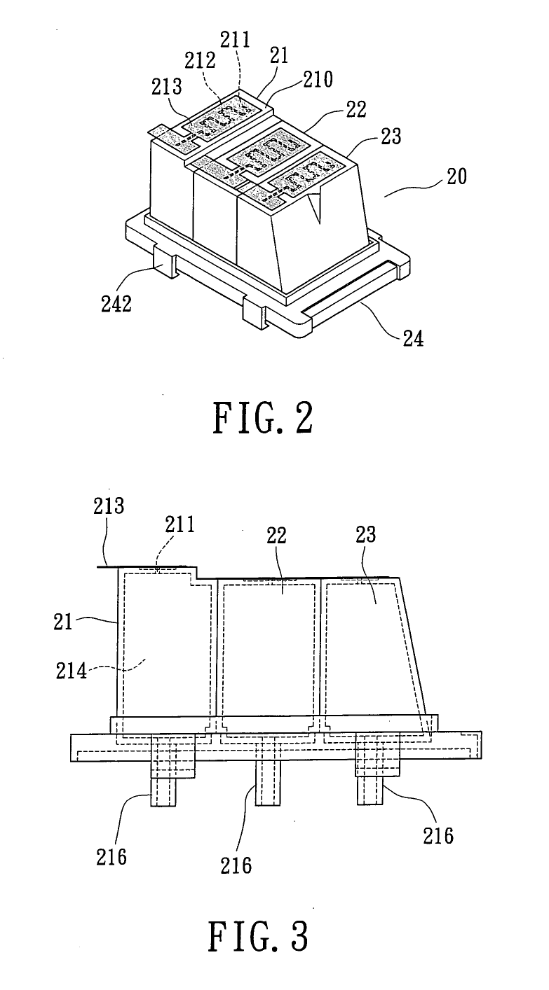

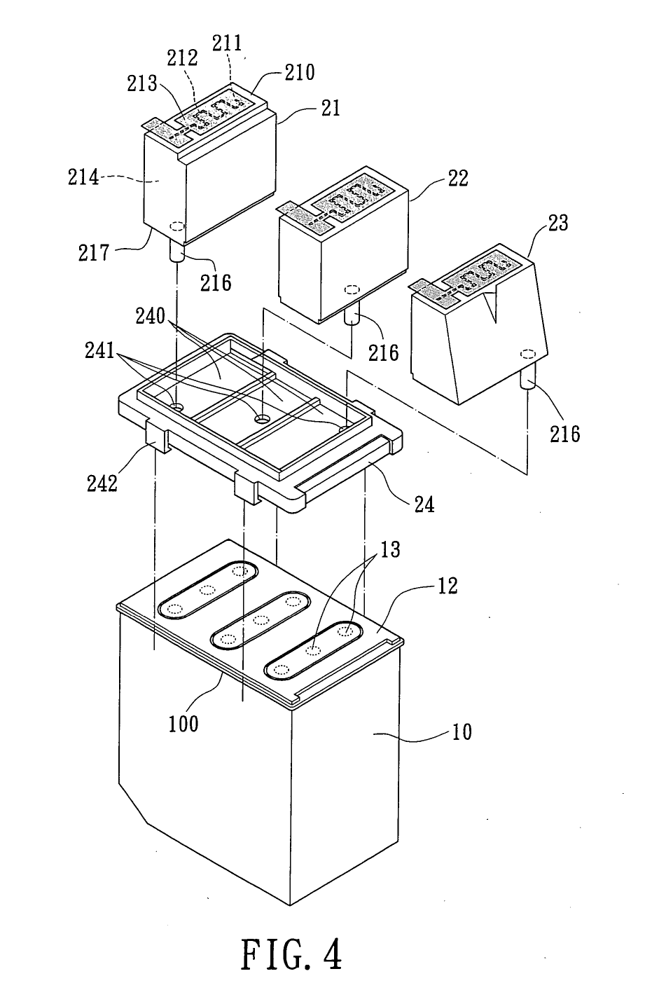

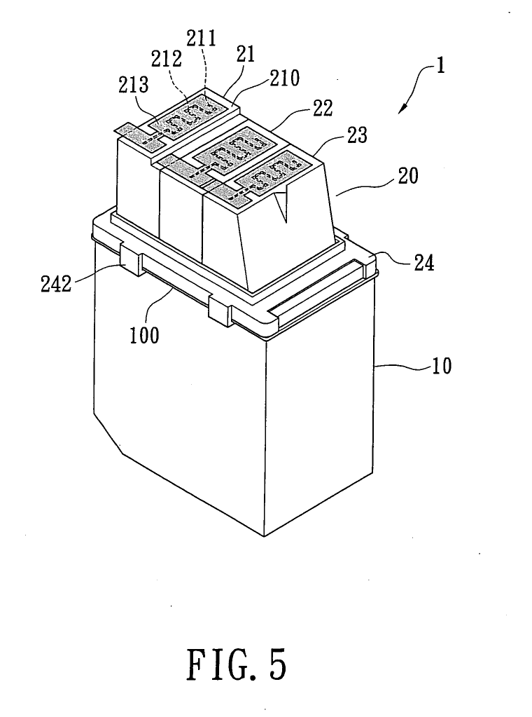

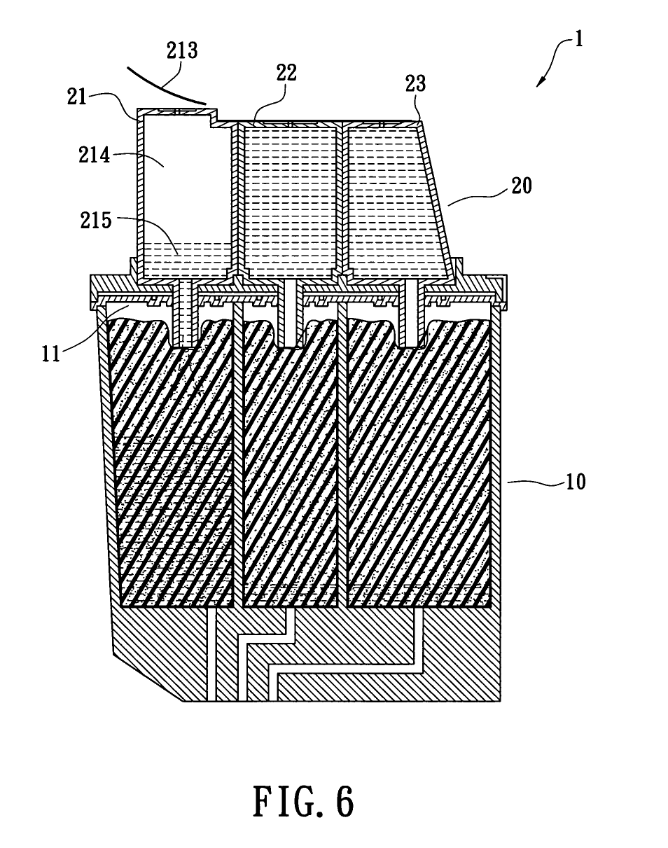

Referring now to FIGS. 2 to 6, the present invention provides an ink cartridge 1 including an ink container 10 and an ink refilling cap 20 assembled on the ink container 10. The ink container 10 has three internal ink reservoirs 11 filled with porous ink storage bodies to absorb different colors of liquid ink. The ink container 10 has an upper surface 12 defining a plurality of openings 13 according to the three internal ink reservoirs 11 for allowing the ink enter an interior of each internal ink reservoir 11. The ink container 10 has a plurality of hooking slots 100 formed at two sides thereof, respectively. The ink container 10 has a corresponding number of ink supply ports formed on the bottoms thereof. The ink supply port communicates with an ink supply needle of a recording head (not shown).

The ink refilling cap 20 provides three individual casings 21, 22, 23. Each of the casings 21, 22, 23 has an accommodating space 214 for filled with different colors of liquid ink 215. Each of the casings 21, 22, 23 is of a transparent material for viewing the ink 215 refilled capacity therein. The casings 21, 22, 23 each include a top wall 210 having an air vent 211 and a circuitous channel 212 formed on a surface of the top wall 210 and in communication with the air vent 211. Three sealing films 213 respectively are attached on the surfaces of the top walls 210 of the three casings 21, 22, 23 for sealing the air vent 211 and the circuitous channel 212 before used to avoid leaking ink.

Furthermore, the circuitous channel 212 is closed off by the sealing film 213 formed from a gas-impermeable material. The sealing film 213 thereby encloses the circuitous channel 212 and forms capillary channels thereof. Thus, air can flow to and from an interior of the ink cartridge 1 through the circuitous channel 212 and the air vent 211, thereby allowing ventilation to the ink cartridge 1 while preventing evaporation of ink. The casings 21, 22, 23 respectively have three drain conduits 216 extending downwardly from a bottom thereof.

In addition, the ink refilling cap 20a further includes a base seat 24 having three frame faces 240 formed on a top thereof. The casings 21, 22, 23 each include a bottom wall 217 mounted on each of the three frame faces 240 of the base seat 24. The base seat 24 has three holes 241 respectively formed on the frame faces 240 for providing the drain conduits 216 of the casings 21, 22, 23 to pass through, correspondingly. The drain conduits 216 of the casings 21, 22, 23 further pass through the openings 13 of the ink container 10, hence the ink is refilled from the air vents 210 of the casings 21, 22, 23 through the drain conduits 216 into the internal ink reservoirs 11 without opening the ink refilling cap 20. The base seat 24 has a plurality of hooks 242 downwardly extended from two edges thereof for coupling with the hooking slots 100 of the ink container 10.

To sum up, the present invention provides an ink refilling design for avoiding the ink cartridge to replace after the ink in the ink cartridge is depleted. In addition, the present invention is based on the convenience or cost that, the ink refilling cap assembled on the ink container of an ink cartridge for refilling ink therefrom needs not open when the ink in the container is depleted.

There has thus been described a new, novel and heretofore unobvious ink refilling cap which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

1. An ink refilling cap adapted to an ink cartridge, comprising:
at least three individual casings each including a top wall having an air vent and a circuitous channel formed on a surface thereof and in communication with the air vent, and the surface of each top wall on which a sealing film attached for sealing the air vent and the circuitous channel before used;
wherein each of the casings has an accommodating space for filled with different colors of liquid ink;
wherein each of the casings has a drain conduit extending downwardly from a bottom thereof; and
a base seat on which the casings are mounted, and the base seat having at least three holes for providing the drain conduits of the casings to pass through, correspondingly.

2. The ink refilling cap of claim 1, wherein each of the casings is of a transparent material for viewing the ink refilled capacity therein.

3. The ink refilling cap of claim 1, wherein the base seat has at least three frame faces formed at a top thereof for receiving bottom walls of the casings, respectively.

4. The ink refilling cap of claim 1, wherein the base seat has a plurality of hooks for coupling with an ink container of the ink cartridge.

5. The ink refilling cap of claim 4, wherein the hooks are downwardly extended from two edges of the base seat, respectively.

6. An ink cartridge, comprising:
an ink container having three internal ink reservoirs and a plurality of hooking slots at two sides thereof, respectively; and
an ink refilling cap assembled on the ink container, comprising:
at least three individual casings each including a top wall having an air vent and a circuitous channel formed on a surface thereof and in communication with the air vent, and the surface of each top wall on which a sealing film attached for sealing the air vent and the circuitous channel before used;
wherein each of the casings has an accommodating space for filled with different colors of liquid ink;
wherein each of the casings has a drain conduit extending downwardly from a bottom thereof; and
a base seat on which the casings are mounted, and the base seat having at least three holes for providing the drain conduits of the casings to pass through, correspondingly;
wherein the base seat has a plurality of hooks downwardly extended from two edges thereof for coupling with the hooking slots of the ink container;
whereby the ink is refilled from the air vents of the casings through the drain conduits into the internal ink reservoirs without opening the ink refilling cap.
